(19) United States
(12) Patent Application Publication
(10) Pub. No.: US 2007/0034435 A1
(43) Pub. Date: Feb. 15, 2007

(54) Adjustable ergonomic vehicles

(76) Inventors: Norman O. Berg, Roseau, MN (US); Ellsworth J. Hagen, Roseau, MN (US); Richard H. Bates JR., Badger, MN (US); Curtis R. Kjaer, Roseau, MN (US)

Correspondence Address: BAKER & DANIELS LLP, 300 NORTH MERIDIAN STREET, SUITE 2700, INDIANAPOLIS, IN, 46204, US

(21) Appl. No.: 11/250,283

(22) Filed: Oct. 14, 2005

Related U.S. Application Data
(60) Provisional application No. 60/631,055, filed on Nov. 24, 2004.

(51) Int. Cl. B62M 27/02

(52) U.S. Cl. 180/190

(57) ABSTRACT

A vehicle includes an adjustable seat adapted to accommodate a rider in a straddle fashion and an adjustable steering assembly. The seat is adapted to provide the rider with a first rider seat position and with a second rider seat position. The adjustable steering assembly is adapted to position a steering member in a first position, corresponding to the first rider seat position, and a second position, corresponding to the second rider seat position. The vehicle further includes a footrest which may or may not be adjustable.

### RELATED APPLICATION

The present application claims priority to U.S. provisional application No. 60/631,055, and incorporates herein, by reference, the entirety of said provisional application.

### TECHNICAL FIELD

The present disclosure relates to adjustable ergonomic vehicles, and more particularly, to a vehicle that permits adjustment of its handlebar position, seat position, and/or its footrest position to ergonomically accommodate riders of different sizes and/or different riding styles.

### BACKGROUND

Ergonomics are important for recreational and utility vehicles, such as snowmobiles, ATVs, utility vehicles, and personal watercraft. Often, a single rider may wish to ride in a variety of styles. Further, a single vehicle may be operated by several different riders over the course of its useful life. These riders are frequently of different heights and sizes. For example, a single vehicle may be operated by both a generally smaller female adolescent and a generally larger male adult. From an ergonomic standpoint, the position of steering members, such as the handlebars and steering post, the height of the seat, and the position of the footrests relative to the rider are important. Handlebars that are too close or too distant, or at an inappropriate height, a seat that is too low, or footrests too far from the seat may provide an inadequate fit for a rider or may render the vehicle unsuitable for a particular riding style.

### SUMMARY SECTION

Accordingly, embodiments of the invention relate to straddle-seat vehicles such as snowmobiles, PWCs, ATVs, and any other currently existing or future developed straddle-seat vehicles that include two or more adjustable components (e.g., handlebar, seat, and/or footrests), and, thereby, allow for an arrangement/configuration of the components in an ergonomically correct configuration for more than one rider and/or for more than one riding mode. Some embodiments specialize in adjusting a rider toward a center of gravity of the vehicle, from a touring mode to a sport mode, and back again.

Some other embodiments of the invention further provide and/or conveniently maintain in a storage memory device of the vehicle, for automatic recall, generally ergonomically static arrangements/configurations of the adjustable components. Thus, a given ergonomically correct arrangement of the components may be quickly changed from a touring mode to a sport mode, and vice versa, while maintaining the ergonomic condition; and in some embodiments such a change may be accomplished when the vehicle is in motion, that is “on the fly”.

### BRIEF DESCRIPTION OF THE DRAWINGS

FIG. 1 shows a side plan view of a snowmobile in accordance with some embodiments of the present invention.

FIG. 2A is a side view of a snowmobile in accordance with some embodiments of the present invention.

FIG. 2B is a diagram depicting a rider position adjustment from a touring mode to a sport mode.

FIG. 2C is a diagram depicting an improved rider position in the sport mode on a snowmobile in accordance with some embodiments of the present invention.

FIG. 3A is a side view of a snowmobile, without adjustable foot rests, in accordance with some embodiments of the present invention.

FIG. 3B is a side view of a snowmobile, without adjustable foot rests, in accordance with some embodiments of the present invention.

FIG. 4A is a side view of a snowmobile, with adjustable foot rests, in accordance with some embodiments of the present invention.

FIG. 4B is a side view of a snowmobile, with adjustable foot rests, in accordance with some embodiments of the present invention.

FIG. 5 is a perspective view of an adjustable seat in accordance with some embodiments of the present invention.

FIG. 6A is a rear view of an adjustable seat in accordance with some embodiments of the present invention.

FIG. 6B is a side view of an adjustable seat in accordance with some embodiments of the present invention.

FIG. 7 is a perspective view of a housing for the pivotal attachment of an adjustable seat in accordance with some embodiments of the present invention.

FIG. 8 shows a side view of a personal watercraft in accordance with some embodiments of the present invention.

FIG. 9 is a side view of a personal watercraft in accordance with some embodiments of the present invention.

FIG. 10 is a side view of a personal watercraft in accordance with some embodiments of the present invention.

FIG. 11 shows a perspective view of an all terrain vehicle in accordance with some embodiments of the present invention.

FIG. 12 is a side view of an all terrain vehicle in accordance with some embodiments of the present invention.

FIG. 13A shows an adjustable seat positioned in a touring mode in accordance with some embodiments of the present invention.

FIG. 13B shows the adjustable seat of FIG. 13A positioned in a sport mode in accordance with some embodiments of the present invention.

FIGS. 14A-B are perspective views of portions of adjustable seat assembly in accordance with an alternate embodiment of the present invention.

FIG. 14C is a section view of an embodiment of the type shown in FIGS. 14A-B.

FIGS. 15A-B are side views of a snowmobile having seat, handle bars and footrests each positioned with respect to one another in a first ergonomic position and second ergonomic position, respectively.

FIG. 16 is a side view of an adjustable seat assembly according to yet another embodiment of the present invention.

FIG. 17A is a perspective view of an adjustable footrest assembly in accordance with one embodiment of the present invention.

FIG. 17B is a schematic side view of the footrest assembly shown in FIG. 17A.

FIG. 18 is a side view of an adjustable footrest assembly according to another embodiment of the present invention.

FIGS. 19A-B are a top view and a section view, respectively, of a footrest according to yet another embodiment of the present invention.

### DETAILED DESCRIPTION

The following detailed description should be read with reference to the drawings, in which like elements in different drawings are numbered identically. The drawings, which are not necessarily drawn to scale, depict selected embodiments and are not intended to limit the scope of the embodiments. Several forms of the embodiments will be shown and described, and other forms will be apparent to those skilled in the art. It will be understood that embodiments shown in drawings and described are merely for illustrative purposes and are not intended to limit the scope of the embodiments as defined in the claims that follow.

Recreational and performance straddle-seat vehicles, such as snowmobiles, PWCs, and ATVs, can provide an enjoyable experience for riders and passengers of such vehicles. “Riders” of these types of vehicles, as used herein, includes the primary operators or drivers of such vehicles, as well as the passengers of such vehicles. This experience can be enhanced by design features that improve the ergonomics of the vehicle. Ergonomic design choices affect the comfort and fatigue level of the rider and/or passengers, as well as the rider's ability to optimally control and maneuver the vehicle in a variety of riding conditions. Three components of such vehicles that may affect ergonomic design are the handlebars, seat, and footrests. An individual rider, for example, may have a preferred spatial arrangement of these three components that accounts for that person's physical characteristics and other personal preferences. Additionally, riders of these types of vehicles typically experience two generally different operating modes, loosely corresponding either to a “racing/sport/rough-water/snow-cross” mode, or to a “touring/leisure/cruising” mode. The terms “sport” and “touring” will be used herein to distinguish between the two generally different operating modes of these types of vehicles.

The “sport” mode of operation typically refers to use of such vehicles where the terrain is rapidly changing and/or where the speed of the vehicle requires the operator to be in a heightened state of responsiveness. This mode typically involves repositioning the operator higher and more forward to obtain greater control of the vehicle and to improve forward visibility. The “touring” mode of operation typically refers to use of such vehicles where the terrain is relatively smooth and unchanging and/or where the vehicle speed is such that the operator is more concerned with the comfort of the rider(s) and less concerned with the immediate threat of collision or loss of control of the vehicle. This mode typically involves repositioning the operator lower and more rearward to provide greater comfort and less fatigue to the rider(s) of the vehicle.

Although the two generally different operating modes are described as distinctly different modes, the adjustments (described in further detail below) used to accomplish each mode may be made either along a continuous adjustment path, or at a number of discrete intervals along an adjustment path. This may enable the operator to “customize” the adjustment between the two operating modes according to individual preference, and allow for varying degrees of adjustment between the two operating modes. For simplicity, the remaining discussion will assume that there are only two generally different operating modes and that the adjustment is essentially a binary operation. However, the invention is not so limited and encompasses the full range of possible adjustments between the “sport” and “touring” operating modes.

An “angular” adjustment of the handlebars, seat, and/or footrests refers to an adjustment wherein a given component moves a certain angle of rotation about an essentially stationary pivot point or axis, and may also include vertical and/or horizontal movement. Angular adjustments may be one way to ergonomically adjust for the two generally different operating modes. For example, an ATV rider encountering steep and/or bumpy terrain may prefer to ride in a position where the rider's center of gravity is repositioned farther forward and higher than it would be if ergonomically adjusted for touring on flat, smooth pavement, while also positioning the rider's body to be angled downward. This may be accomplished by pivotally adjusting the seat and/or handlebars about an axis that extends horizontally in a direction transverse to the longitudinal axis of the vehicle chassis. Although such an axis for adjustment may be physically present on the vehicle, as may be the case with a rotatable mount attached to the vehicle chassis, an angular adjustment may also be accomplished with equivalent means, such as with a pair of slidable arcuate supports, for example, which may provide a combination of vertical, horizontal, and angular adjustments.

An “ergonomically correct” arrangement refers to a spatial arrangement of the handlebars, seat, and/or footrests in a vehicle where the relative position of these three components is comfortable for a given rider. An “ergonomically static” condition refers to the ability of a vehicle to maintain a given ergonomic spatial arrangement while shifting from one operating mode to another.

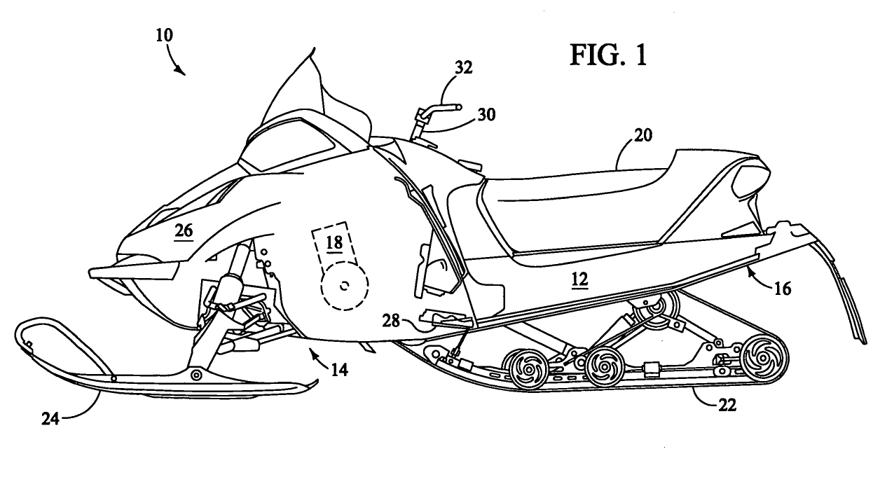

The present invention is best understood with reference to the accompanying drawing figures. A snowmobile 10 in accordance with some embodiments of the present invention is shown in FIG. 1. Generally, snowmobile 10 includes a longitudinally extending chassis 12 having a front portion 14 and a rear portion 16. The chassis 12 supports and mounts several vehicle components, including an engine 18, a seat 20, a drive track 22, a pair of steerable skis 24, and a body assembly 26. In some embodiments, the chassis 12 supports the engine 18 proximate the front portion 14 and the seat 20 proximate the rear portion 16. The seat 20 is adapted to accommodate a rider in straddle fashion, and the engine 18 powers the drive track 22 operatively connected to the chassis 12 proximate the rear portion 16. Means for supporting a rider's feet extending longitudinally below opposite lateral sides of the seat 20 may be provided. In some embodiments, the means may include footrests 28 that extend longitudinally below opposite lateral sides of the seat 20. The chassis front portion 12 may be suitable for mounting the pair of steerable skis 24 and supporting the body assembly 26. The body assembly 26 may contain the engine 18. A steering post 30 is operatively connected to the pair of skis 24. Means for rotating the steering post 30 to effect steering may be provided, and the means for rotating may be supported by the steering post 30. In some embodiments, the means for rotating may include a steering control, such as handlebars 32, supported by the steering post 30.

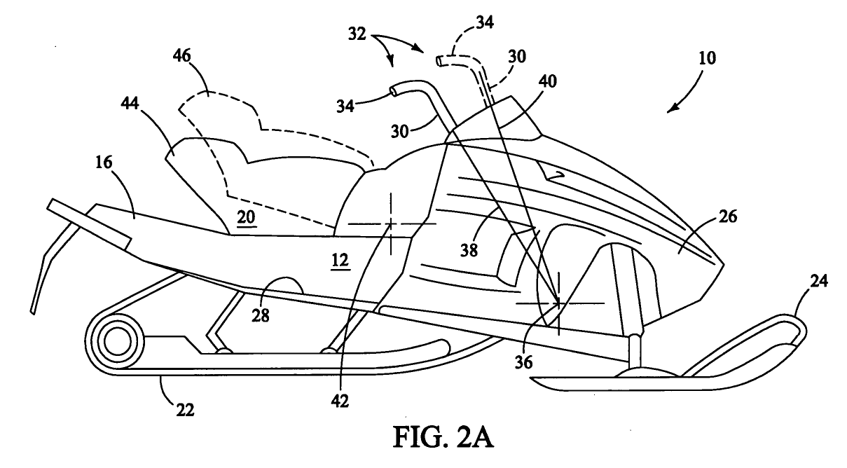

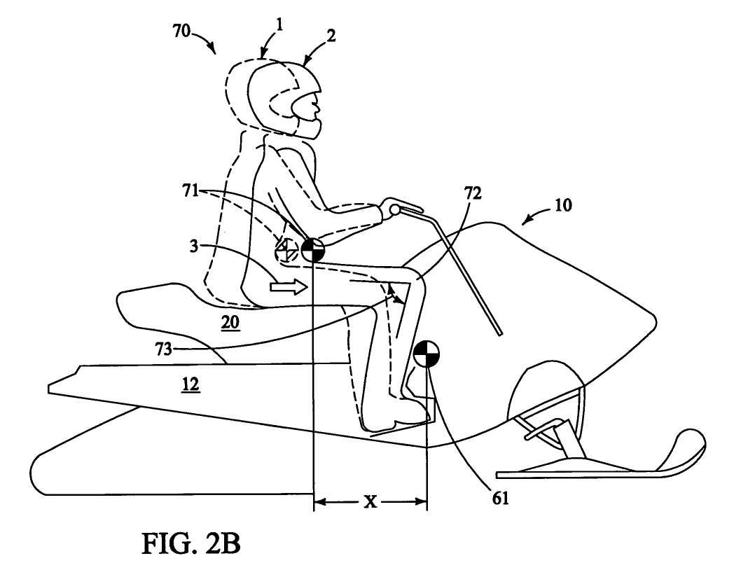

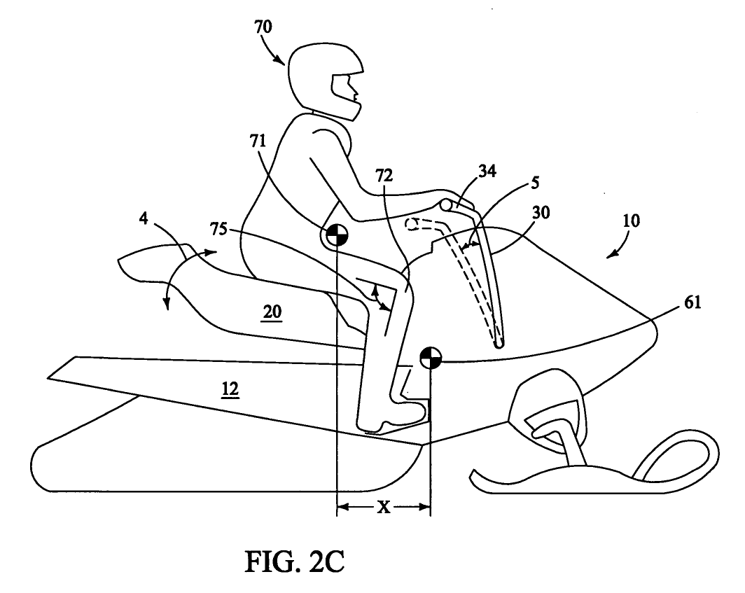

FIG. 2A is a side view of an embodiment of a snowmobile 10 with adjustable steering post 30 or handlebars 32 and seat 20. The embodiment shown may allow for angular adjustment of the handlebar 32 and grip 34 assembly about an axis 36 that extends generally horizontally and perpendicular to either the forward direction of travel or the longitudinal axis of the snowmobile 10. The angular adjustment may allow the handlebar 32 and grip 34 assembly to shift between a relatively rearward and downward touring mode position 38 (shown in solid lines) and a relatively upward and forward sport mode position 40 (shown in phantom), and back, as needed by the rider. Although axis 36 is shown towards the bottom of the steering post 30 in FIG. 2A, it is understood that the axis 36 and its corresponding pivot point could be moved higher on the steering post. An example of a handlebar adjustment mechanism that can be used in conjunction with embodiments of the present invention is described in co-pending and commonly-assigned U.S. patent application Ser. No. 10/903,464, filed on Jul. 30, 2004, the entire disclosure of which is incorporated by reference herein.

Similarly, the embodiment shown in FIG. 2A may allow for angular adjustment of the seat 20 about an axis 42 that extends generally parallel to axis 36. The angular adjustment may allow the seat 20 to shift between a relatively lower touring mode position 44 (shown in solid lines) and an upwardly angled sport mode position 46 (shown in phantom lines), and back, as needed by the rider.

FIG. 2B is a diagram depicting a rider position adjustment from a touring mode to a sport mode on a current state of the art snowmobile. FIG. 2B illustrates snowmobile 10 including a first center of gravity (cg) 61, and a rider 70, seated upon snowmobile 10, rider 70 including a second cg 71; rider 70 is shown with phantom and solid lines to illustrate a shift of rider 70 forward from a touring mode position 1 to a sport mode position 2, respectively, per arrow 3. As can be seen in FIG. 2B, the shift of rider 70 from aft position 1 to fore position 2 moves cg 71 of rider 70 along chassis 12 such that a horizontal gap between rider cg 71 and snowmobile cg 61 is reduced to ‘x’, thereby enabling rider 70 to use his weight more effectively in maneuvering snowmobile 10. Furthermore, it may be easier for rider 70 in position 2 to lift himself up off seat 20 thereby reducing the horizontal gap between cg 71 and cg 61 even more. However, position 2 of rider 70 as illustrated in FIG. 2B is not optimal from an ergonomical standpoint. For example, FIG. 2B further shows a knee 72 of rider 70 being bent to a relatively acute angle 73 when rider moves into position 2; such a bending of knee 72 can cause leg fatigue over time.

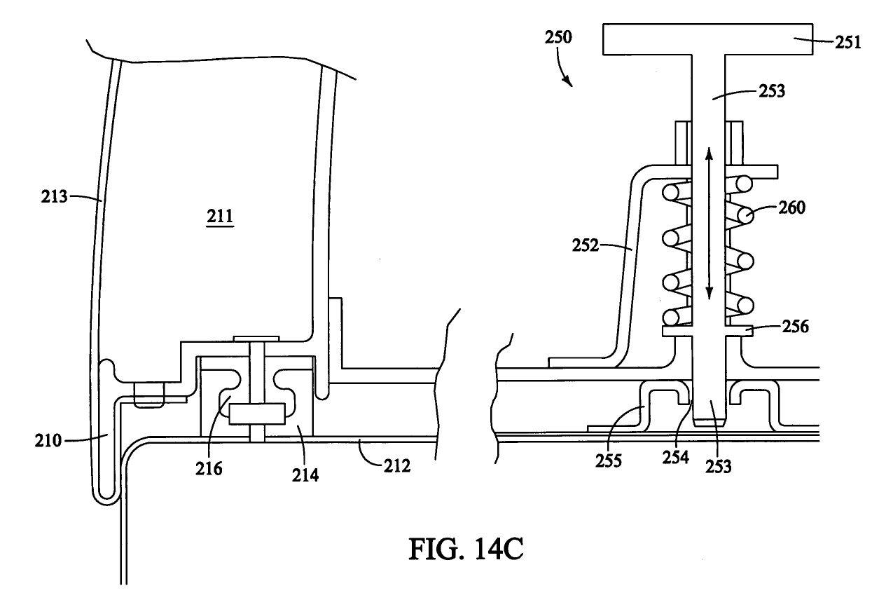

FIG. 2C is a diagram depicting an improved rider position on a snowmobile according to some embodiments of the present invention. FIG. 2C illustrates snowmobile 10, as previously described in conjunction with FIG. 2A, including seat 20 that adjustable, per arrow 4, and steering post 30 that is also angularly adjustable, per arrow 5. As can be seen in FIG. 2C, adjustment of seat 20 per arrow 4 shifts cg 71 of rider 70 forward and upward into a sport mode position, similar to position 2 illustrated in FIG. 2B in that the horizontal gap between cg 71 and cg 61 of snowmobile 10 is reduced to ‘x’ for improved maneuverability as previously described. According to the illustrated embodiment, seat 20 provides a more ergonomically correct position for rider 70 in sport mode, for example knee 72 is less bent as illustrated by a more open angle 75. Additionally position of handle bar 34 is shown, adjusted forward by angular adjustment of steering post 30, per arrow 5, to accommodate the more forward position of rider 70. Furthermore, the rider position illustrated in FIG. 2C, accommodated by adjustable seat 20 and steering post 30, may help rider 70 to raise up off seat 20 with less physical effort. Although FIG. 2C shows seat 20 being angularly adjustable with respect to chassis 12, alternate embodiments of the present invention, described below in conjunction with FIGS. 14A-C, 15A-B and 16, include seats that can be adjusted while maintaining a fixed angular orientation with respect to a chassis of a vehicle.

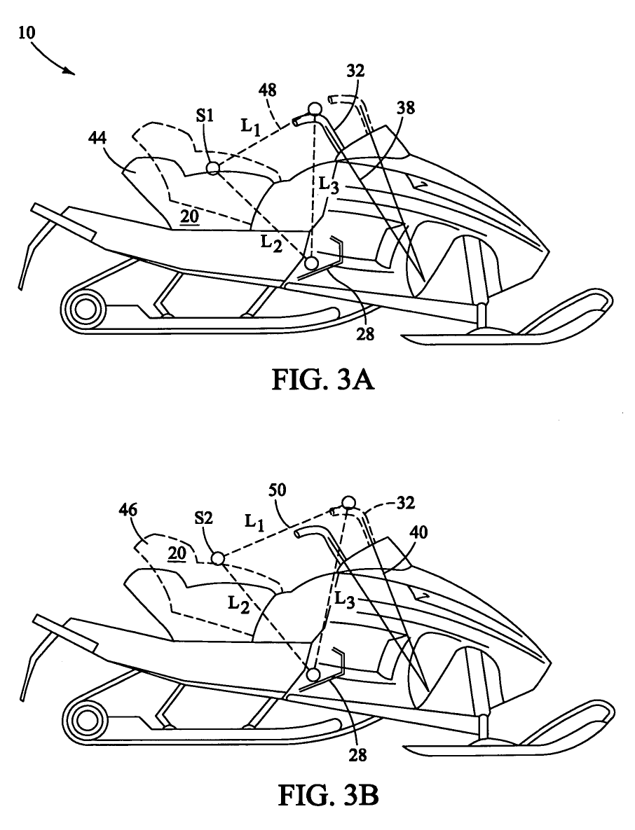

FIG. 3A is a side view of an embodiment of snowmobile 10 with a fixed footrest configuration, showing the spatial arrangement of the seat 20, handlebar 32, and footrests 28 when the seat 20 and handlebar 32 are angularly adjusted to the touring mode position 38, 44. The triangle 48 drawn in dotted lines (formed by L1, L2, and L3) between the rider's likely seat position S1 on seat 20, the handgrips on handlebar 32, and footrests 28, illustrates the relative positioning and distancing of these three components.

FIG. 3B is a side view of the embodiment of FIG. 3A where the seat 20 and handlebars 32 are pivoted to an upper/forward sport mode position 40, 46. The triangle 50 drawn in dotted lines (formed by L1, L2, and L3) between the rider's likely seat position S2 on seat 20, the handgrips on handlebar 32, and footrests 28, illustrates the relative positioning of these three components. As may be seen by a comparison of FIGS. 3A and 3B, the triangle 48 formed by the components in the touring mode generally maintains its shape as triangle 50 when shifting to the sport mode. This indicates that the distances L1, L2, and L3 between these components may remain relatively constant when shifting between the two operating mode positions. Accordingly, the vehicle's ergonomics is not greatly affected by the shift from one mode to the other.

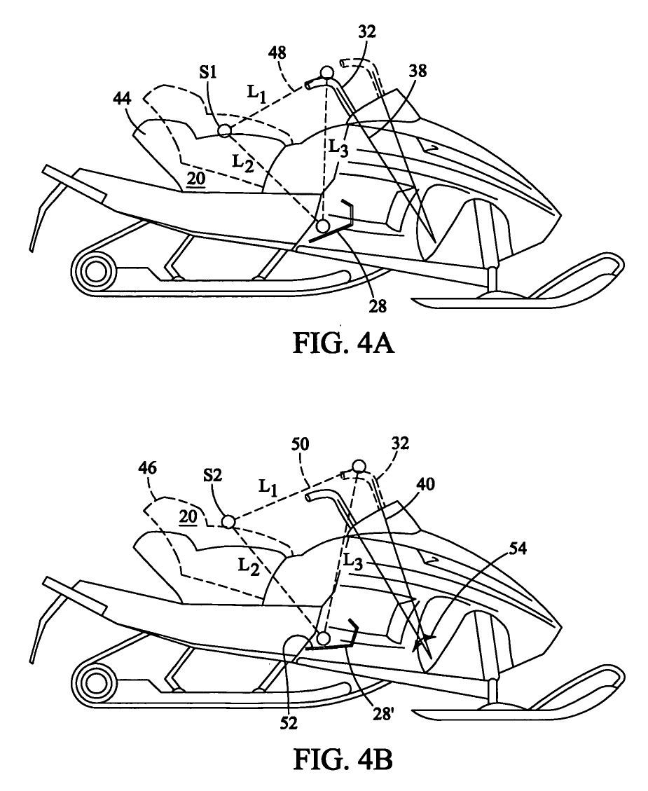

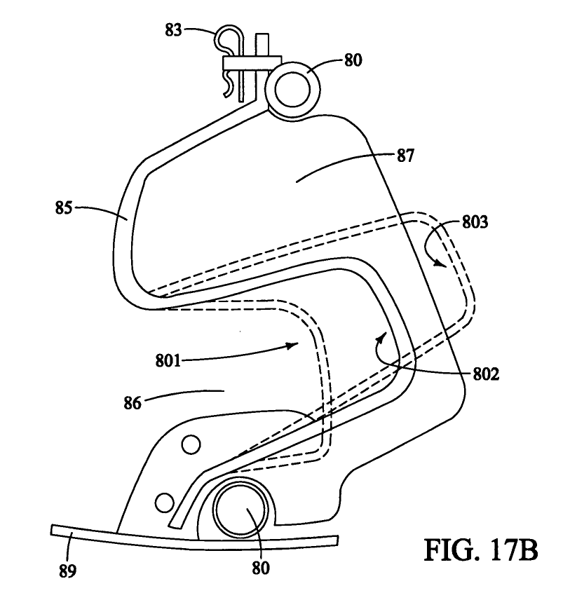

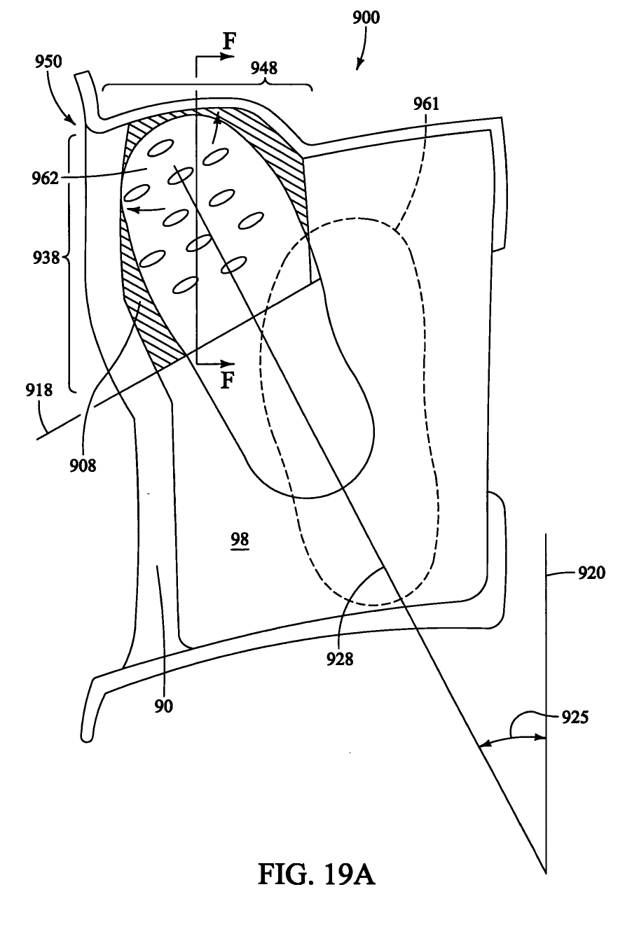

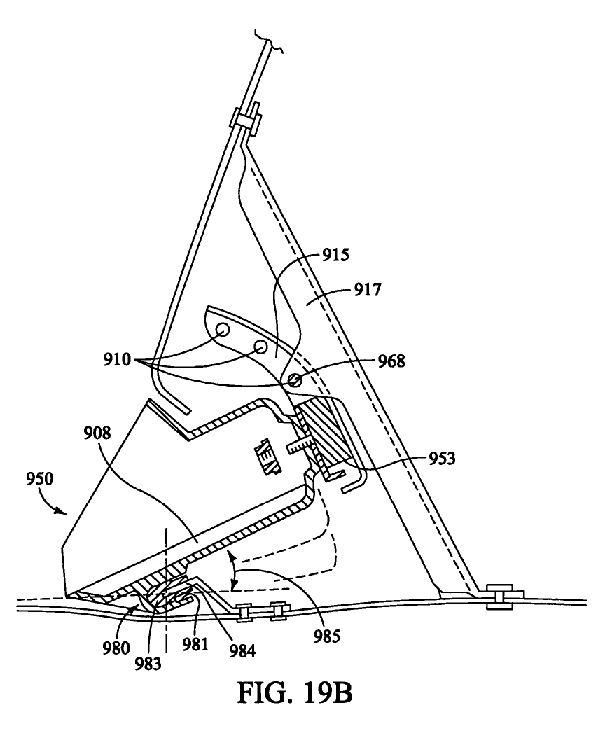

FIGS. 4A and 4B are side views of an alternate embodiment of a snowmobile 10 with adjustable footrests 28′, showing again the spatial arrangement of the seat 20, handlebar 32, and footrests 28′ when the seat 20, handlebar 32, and footrests 28′ are angularly adjusted between the touring and sport mode positions. The illustrated embodiment allows for angular adjustment of the footrests 28′, and may thereby also allow the spatial arrangement to remain nearly ergonomically static when shifting between the touring mode and the sport mode. As shown in FIG. 4B, a surface 52 of footrests 28′ has been pivotally adjusted downward to accommodate seat position S2; an embodiment of such a footrest is described in greater detail in conjunction with FIG. 19B. Optionally, the position of footrests 28′ may also be moved fore and aft as indicated by arrow 54 in FIG. 4B. In all positions, the triangles 48, 50 (formed by L1, L2, and L3) retain their same general shape, indicating that an ergonomically static arrangement has been generally maintained in moving between the two different operating modes. Incorporation of adjustable footrest assemblies according to various embodiments of the present invention will be further described in conjunction with FIGS. 17A-B, 18 and 19A-B.

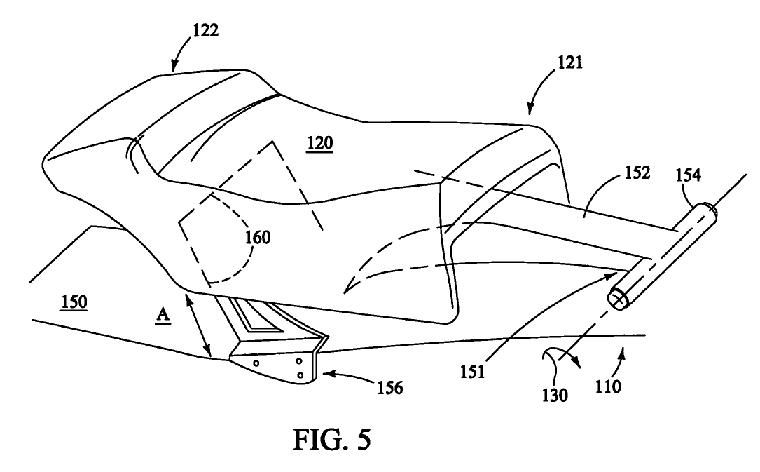

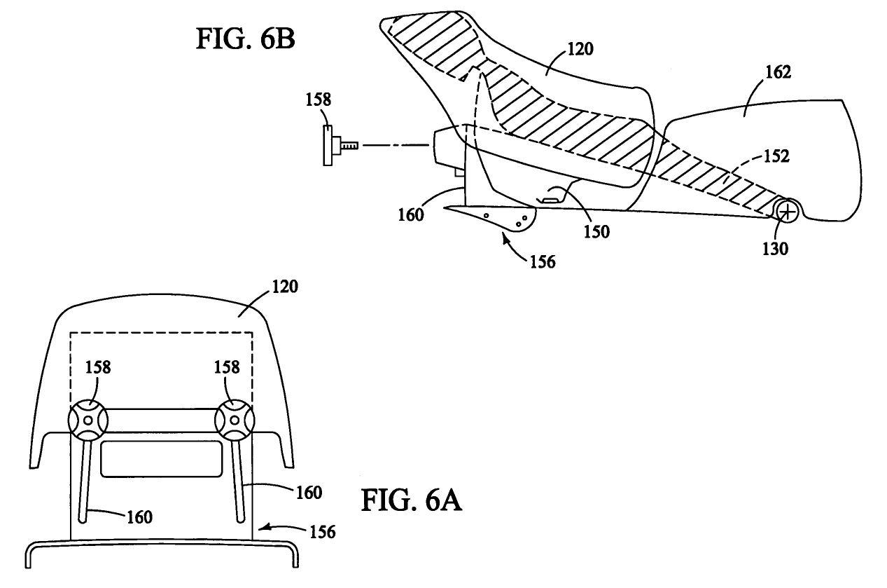

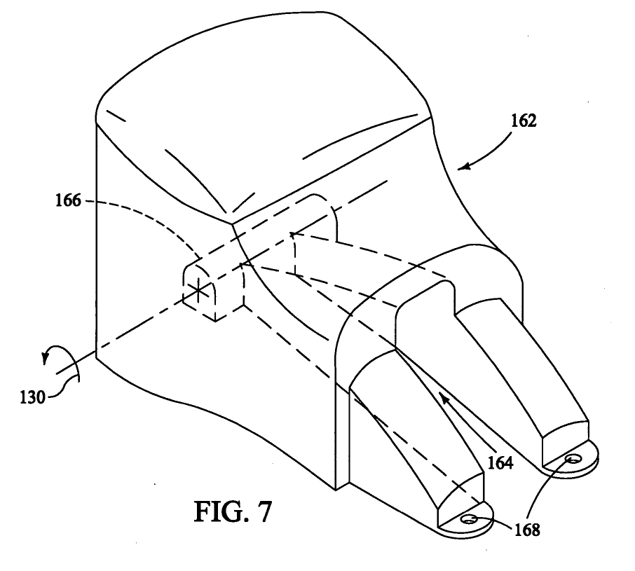

FIGS. 5, 6A, and 6B show a perspective view, rear view, and side view, respectively, of an adjustable seat 120 for a vehicle 110 such as a snowmobile, ATV, or watercraft in accordance with some embodiments of the present invention. The seat 120, including a front end 121 and a back end 122, may be pivotally adjusted, per arrow A, about an axis 130 from a sport mode position, for example as shown in FIGS. 3B and 4B to a touring mode position, for example as shown in FIGS. 3A and 4A, and vice versa. The pivotal adjustment of seat 120 about axis 130 may be accomplished by mounting seat 120 to vehicle chassis 150 by means of a seat pivot arm 152 that extends from the seat 120 to the axis 130, terminating with a seat pivot rod 154 at a first end 151 of seat pivot arm 152 for pivotal attachment to chassis 150, rotatable about axis 130. A seat support 156 may be mounted to the vehicle chassis 150 rearward of the pivotal attachment about axis 130.

The seat support 156 may comprise a three-sided mount that may extend upwardly from the vehicle chassis 150 to support the seat 120 in either of its two operating modes. One or more fastening devices 158 (FIG. 6A-B) may be used to secure the seat 120 in either of the two operating mode positions, by positioning fastening devices 158 through channels 160 formed in the seat support 156, and fastening the seat 120 to the seat support 156 at the appropriate or desired amount of angular adjustment.

FIG. 6A is a rear view of an adjustable seat 120 in accordance with an embodiment of the present invention. Fasteners 158 may be employed to lock seat 120 into either the touring mode position or the sport mode position by sliding seat 120 and fasteners 158 upward in channels 160 formed in the seat support 156 and tightening at the desired amount of angular adjustment. The fasteners 158 may, for example, have threads which may be received by threaded openings (not shown) in the seat 120.

FIG. 6B is a perspective view of an adjustable seat 120 in accordance with a particular embodiment of the present invention showing the pivotal axis 130 located on or near the surface of the vehicle chassis 150. Securing of the seat at the proper amount of adjustment is not limited to the specific embodiment shown in FIGS. 6A and 6B. For example, securing of the seat adjustment may be provided in a variety of ways, including but not limited to turn screws, pin and shaft assemblies, and inclined bar and retainer assemblies or the like. Securing of the seat adjustment may also be accomplished or facilitated with a biasing assembly, such as a biasing spring or some other biasing member.

FIG. 7 is a perspective view of a housing 162 for mounting and supporting the pivotal attachment of an adjustable seat in accordance with an embodiment of the present invention. The housing 162 may be formed by a concave outer surface of a gas tank of a vehicle and covers the seat pivot arm 152 and seat pivot rod 154 (FIG. 5), providing a recess 164 that allows for the pivotal movement of seat pivot arm 152 about the axis 130. The housing 162 further includes a generally cylindrical hollow 166 that holds and provides a space for mounting and pivotal rotation of seat pivot rod 154. The housing 152 may be attached to the vehicle chassis via one or more housing support mounts 168, which may also provide support for the seat 120.

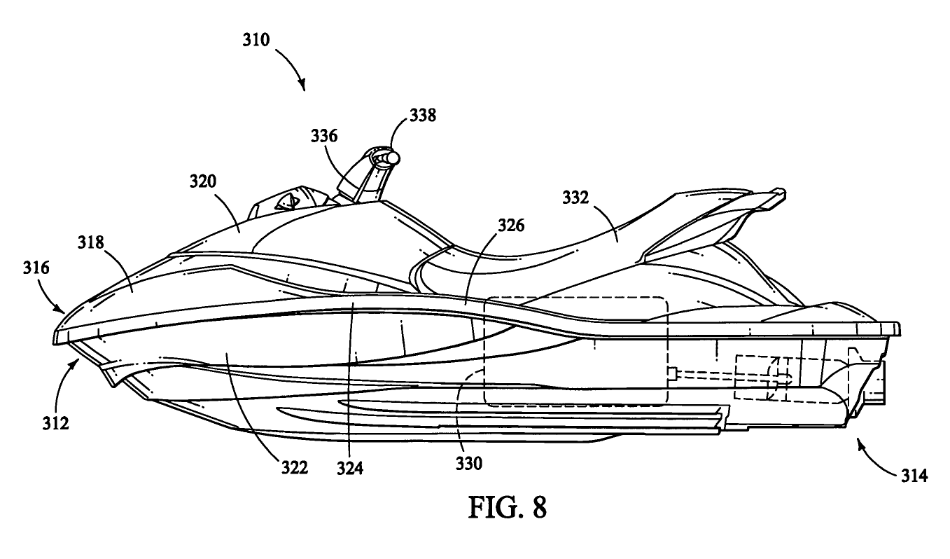

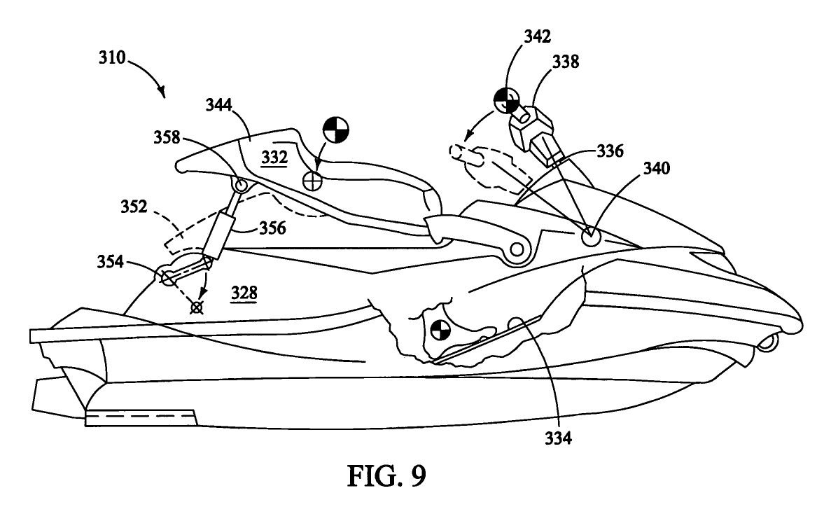

A watercraft 310 in accordance with some embodiments of the present invention is shown in FIG. 8. Watercraft 310 has generally a front or bow 312 and a rear or stem 314 and includes an upper portion 316 that includes a top deck 318 and shroud 320. The top deck 318 is secured to a bottom hull 322 along an overlapping portion 324 covered with a rub rail 326, thereby forming a hull 322. The hull 322 can serve as a chassis for mounting and supporting other watercraft vehicle components. The hull 322 and top deck 318 define a compartment sized to house an internal combustion engine 330 for powering the watercraft 310. The deck 318 also has a raised, longitudinally extending seat 332 adapted to accommodate one or more riders seated in straddle fashion. A footrest 334 area is also provided as shown in FIG. 9. A steering post 336 is operatively connected to a jet useful for providing steering to the watercraft 310. Handlebars 338 supported by the steering post 336 may be provided for rotating the steering post 336 to effect steering.

FIG. 9 is a side view of the PWC 310 partially cut away to expose footwells 334 in accordance with some embodiments of the present invention. According to the illustrated embodiment, the PWC 310 allows angular adjustment of the seat 332, about an axis 348 that extends generally horizontally and perpendicular to the forward direction of motion of the PWC 310, and of the handlebars 338 and/or steering post 336, about a generally horizontal axis 340 generally perpendicular to the forward direction of motion of the PWC 310. Such angular adjustment may enable movement of the handlebar 338 and handgrips 342 assembly from a sport mode position (shown in solid lines), corresponding to a seat position 344 (shown in solid lines), to a touring mode position (shown in phantom), corresponding to a seat position 352 (shown in phantom), and vice versa. FIG. 9 also shows components supporting the seat 332 in the sport mode position 344 that include a pivot 354, which may be pivotally mounted to the hull 322, pivotally connected to a shock absorber link 356, which is mounted to the seat 332 by a bracket 358; link 356 may provide a cushioned ride during sport mode operation of the PWC. The components illustrated supporting seat 332 in FIG. 9 may be incorporated to support seat 20, illustrated in FIGS. 1-4B, to form alternate embodiments.

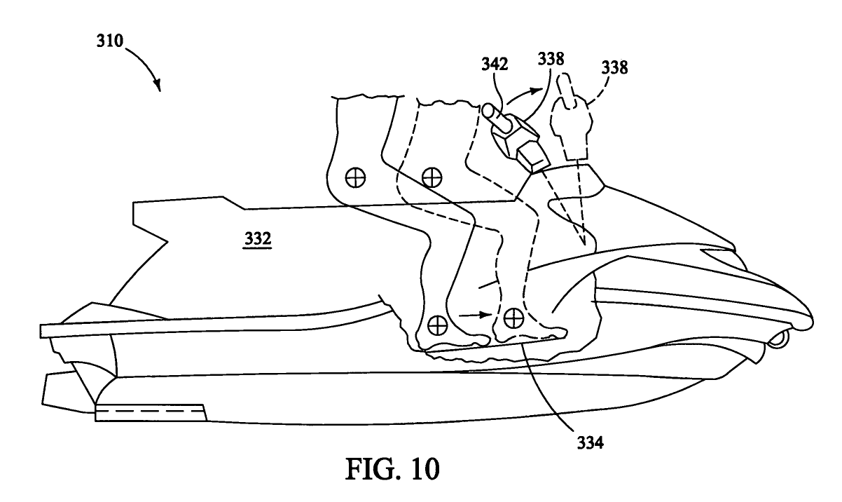

FIG. 10 is a side view of a PWC 310 cutaway to expose rider footrest 334 in accordance with some embodiments of the present invention in which angular adjustment of the handlebar 338 and grip 342 assembly in the forward direction may allow for the PWC 310 to accommodate and evenly distribute the weight of one or more additional passengers.

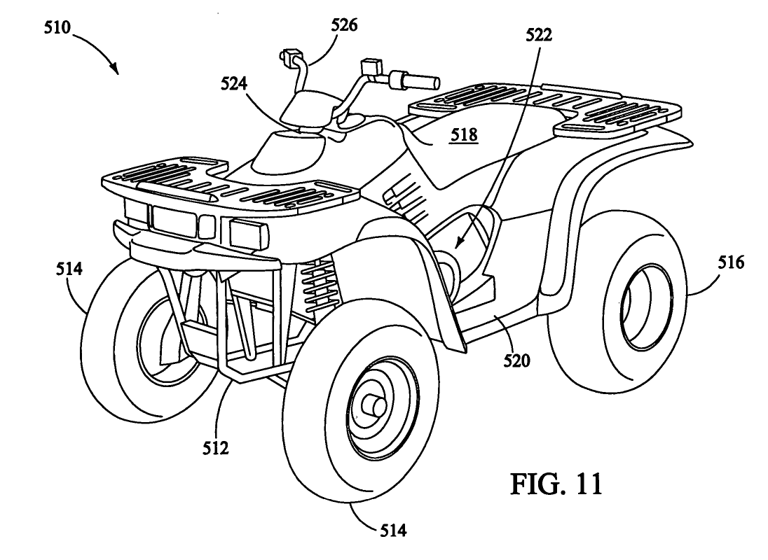

An ATV 510 in accordance with some embodiments of the present invention is shown in FIG. 11. ATV 510 includes a chassis 512, two front wheels 514 and two rear wheels 516, a straddle-type seat 518, laterally extending footrests 520 on opposite sides of the vehicle, and an engine 522 located generally beneath the straddle-type seat 518 and substantially between the footrests 520. A steering post 524 is operatively connected to the pair of wheels 514. Handlebars 526 supported by the steering post 524 may be provided for rotating the steering post 524 to effect steering.

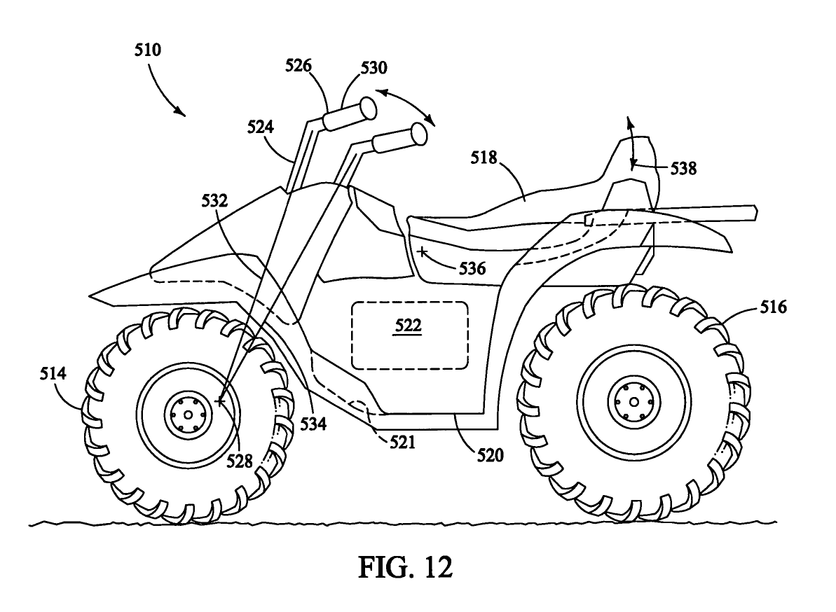

FIG. 12 is a side view of an ATV 510 in accordance with an embodiment of the present invention. The ATV 510 illustrated in FIG. 12 allows angular adjustment of the handlebar 526 about an axis 528, which extends generally horizontally and perpendicular to the forward direction of motion of the ATV 510, enabling movement of the handlebars 526 and handgrip 530 assembly from a relatively forward sport mode position 532 to a relatively rearward touring mode position 534, and vice versa. Similarly, the ATV 510 allows angular adjustment of the seat 518 about an axis 536, which extends generally horizontally and perpendicular to the forward direction of motion of the ATV 510, enabling movement of the seat 518 from a lower touring mode position 538 to an upwardly angled sport mode position, and vice versa. FIG. 12 further illustrates footrest 520 including an inclined foot support surface 521 that may provide an ergonomic riding position in any riding modes and may further prevent a rider's foot from sliding forward; further detail concerning inventive embodiments of such a footrest is provided in conjunction with FIGS. 19A-B. It should be noted that ATV 510 may include any of the types of adjustable seats and footrests described herein.

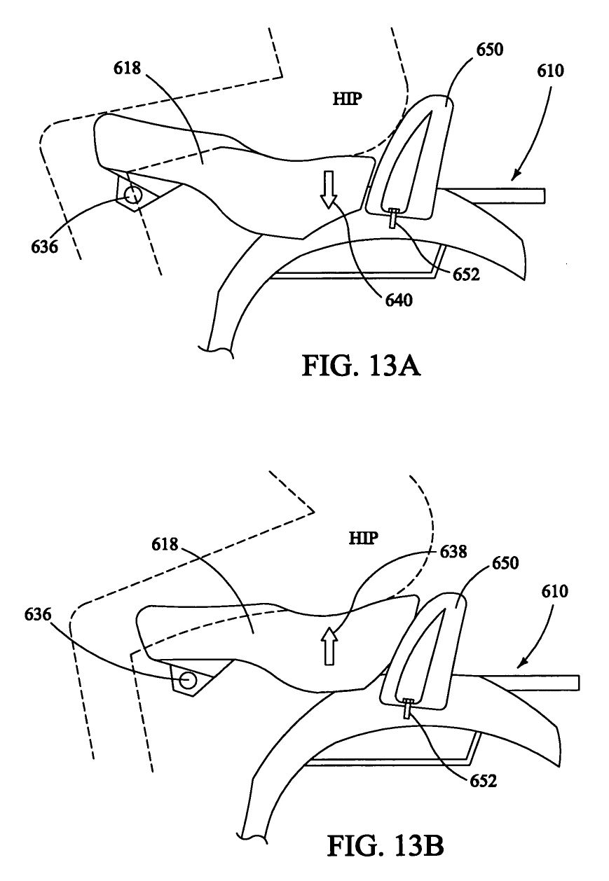

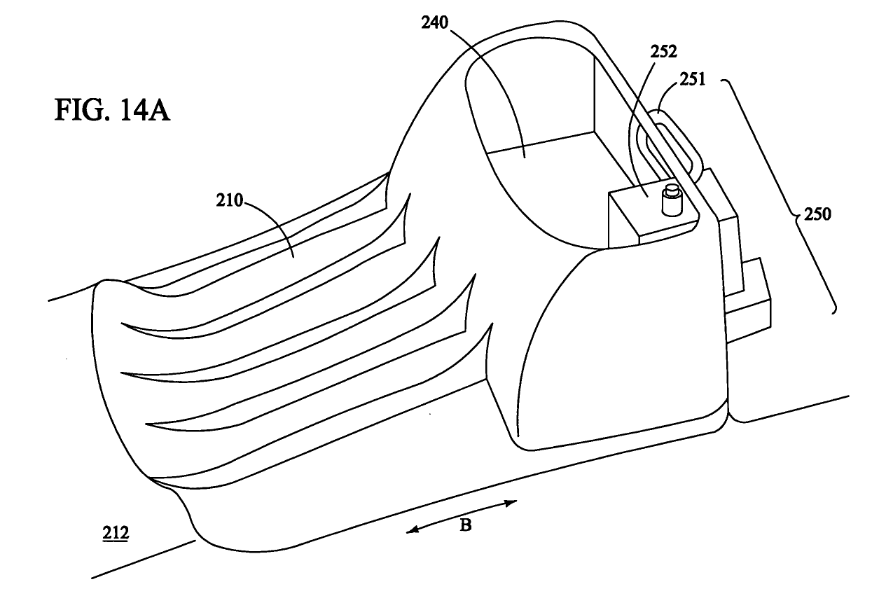

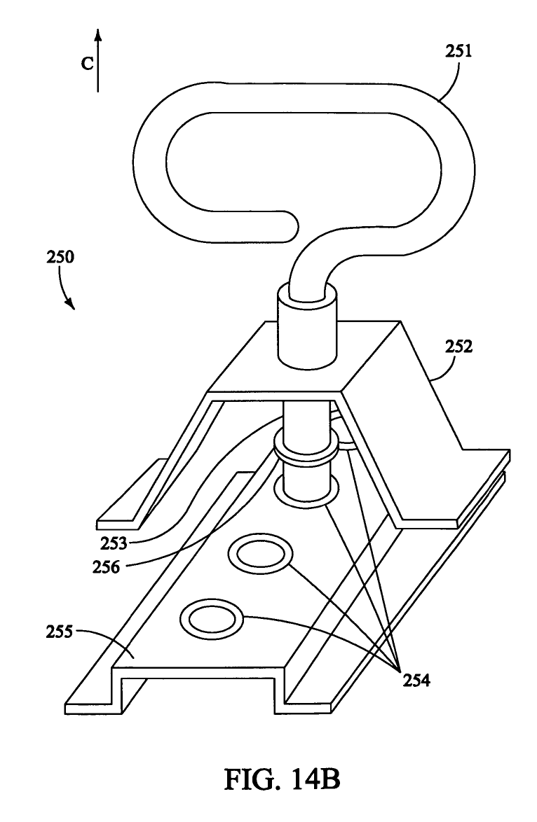

FIGS. 13A and 13B are side views of an alternate embodiment of an adjustable seat 618 mounted on a vehicle 610, such as any of the recreational vehicles 10, 310, 510 discussed above. Similar to the embodiments discussed above, the seat 618 pivots about an axis 636 that extends in a horizontally and generally perpendicular to the forward direction of motion of the vehicle. Such angular adjustment may enable movement of the seat 618 from a sport mode position 638 (FIG. 13B) to a touring mode position 640 (FIG. 13A), and vice versa. The particular embodiment shown in FIGS. 13A and 13B incorporates a backrest 650, which may remain substantially stationary relative to the to the vehicle 610. The backrest 650 may be mounted to the vehicle 610 via a fastener 652, or any other suitable means. Thus, backrest 650 may provide support for a rider, a portion of which is indicated with phantom lines, in the touring mode (FIG. 13A), and is approximately flush or slightly above a top of seat 618 when adjusted for the sport/explorer mode (FIG. 13B), which may enable the rider to move and shift body position easily in this mode.

FIGS. 14A-B are perspective views of portions of an adjustable seat assembly according to an alternate embodiment of the present invention. FIG. 14A illustrates the adjustable seat assembly including a seat base 210, preferably formed from a hard plastic, held in place on a chassis 212 of a vehicle via a latch mechanism 250 coupled to a rear portion of seat base 210 in proximity to a cavity 240 which may be used for storage. According to some embodiments of the present invention, when latch mechanism 250 is released, seat base 210 slides fore and aft along chassis 212, per arrow B, by means of a guide track and runner assembly, one embodiment of which is described in conjunction with FIG. 14C. FIG. 14B illustrates latch mechanism 250 including a latch bar 253 extending from a latch handle 251 and through a latch guide 252, which would be coupled to seat base 210. FIG. 14B further illustrates latch bar 253 being inserted within one of a plurality of latch detents 254, which, in the illustrated embodiment, are formed by holes in a rail 255 that would be coupled to chassis 212; a location of each detent 254 corresponds to a different seat position. Thus, according to one embodiment illustrated by FIGS. 14A-B, a vehicle rider may slide seat base 210 fore and aft along chassis 212 by pulling up latch handle 251, per arrow C, so that latch bar 253 is free of detents 254; once at a desired seat position, the rider may lock seat base 210 in place by positioning latch bar 253 within the corresponding detent 254. Alternately, movement of seat base 210 may be accomplished by electrical or hydraulic actuation.

FIG. 14C illustrates an embodiment of a guide track and runner assembly for an adjustable seat assembly of the type shown in FIGS. 14A-B, wherein a guide track 214 is coupled to chassis 212, and a runner 216, shown engaged within guide track 214, is coupled to seat base 210. Also shown in FIG. 14C is a portion of a seat mounted on seat base 210 including a foam cushion 211 and a seat cover 213. FIG. 14C further illustrates latch mechanism 250 including a spring 260 wound about latch bar 253 and held between latch guide 252 and a protruding ledge 256 of latch bar 253; spring 260 forces latch bar 253 into detent 254 to lock seat base 210 in a selected position.

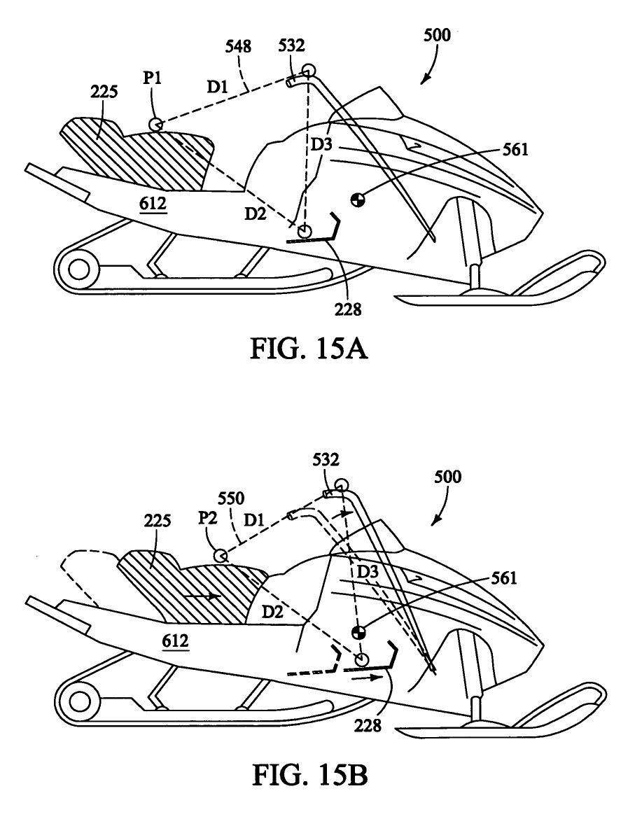

FIGS. 15A-B are side views of a snowmobile having seat, handle bars and footrests each positioned with respect to one another in a first ergonomic position and second ergonomic position, respectively. FIGS. 15A-B illustrate snowmobile 500 including a cg 561, a seat 225, which may be part of the adjustable seat assembly described in conjunction with FIGS. 14A-C, a handlebar 532, adjustable as previously described in conjunction with FIG. 2A, and an adjustable footrest 228. In FIG. 15A, seat 225 (including a rider's likely seat position P1), handlebar 532 and footrest 228 are all positioned relatively aft along a chassis 612 in more of a touring mode, while, in FIG. 15B, each of the aforementioned elements, including the rider's likely seat position P2, are positioned relatively fore along chassis 612, closer to a vertical alignment with cg 561, in more of a sport mode. FIG. 15A shows a triangle 548 and FIG. 15B another triangle 550, both triangles made up of distances D1, D2 and D3; according to embodiments of the present invention in both positions, the triangles 548, 550 retain their same general shape, indicating that an ergonomically static arrangement has been generally maintained in moving between the two different operating modes. It should be understood that adjustment from the first ergonomic position to the second ergonomic position may be motivated by a change from a first rider to a second rider, rather than a change in riding modes, wherein the second rider is generally smaller than the first rider.

According to some embodiments of the present invention, as illustrated in FIGS. 15A-B, adjustable footrest 228 is slideably attached to chassis 612 for movement in a fore and aft direction. Embodiments of such adjustable footrests are described in conjunction with FIGS. 17A-B and 18. Alternately or additionally footrests may be pivotally attached to chassis 612 as described in conjunction with FIGS. 4A-B and FIG. 19B.

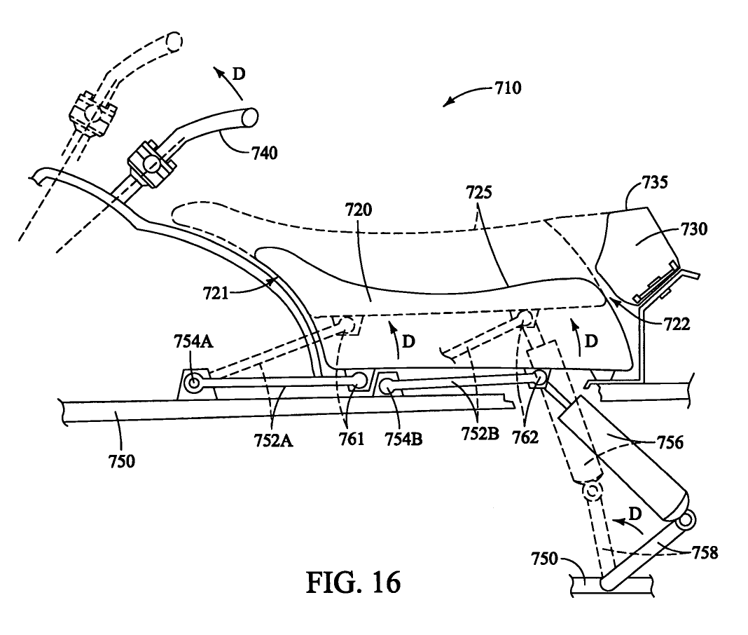

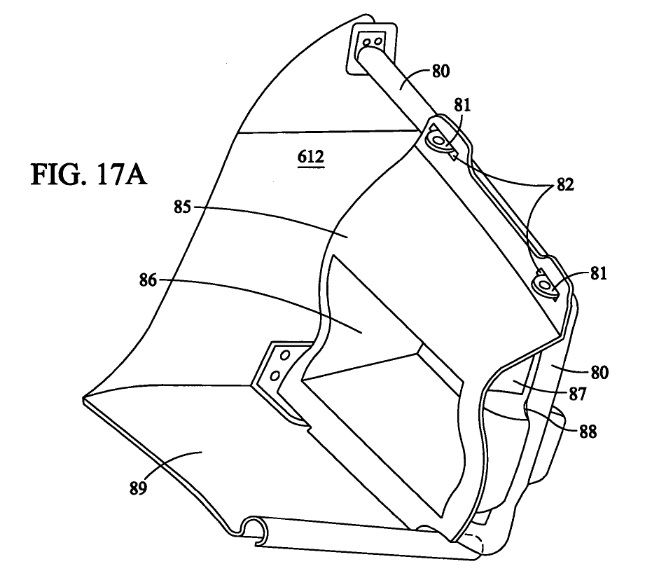

FIG. 16 is a side view of an adjustable seat assembly according to yet another embodiment of the present invention. FIG. 16 illustrates a vehicle 710, which may be any of an ATV, a watercraft and a snowmobile, including a seat 720 and a handle bar 740 both adjustable, via arrows D, from a first position, shown for each with a solid line and generally corresponding to a touring mode, to a second position, shown for each with phantom lines and generally corresponding to a sport mode. Seat 720 and handle bar 740 in the second position may provide an ergonomically sound position for a rider, similar to that shown in FIG. 2C except that seat 720 maintains a fixed angular orientation. FIG. 16 further illustrates vehicle 710 including a backrest 730 having an upper surface 735 positioned above an upper surface 725 of seat 720, in the first position, and positioned approximately flush with upper surface 725 of seat 720, in the second position. Backrest 730, thus provides support for a rider in the touring mode and does not interfere with the rider when moving and shifting body position in the sport mode.

According to the embodiment illustrated in FIG. 16, seat 720 is adjustably attached to a chassis of vehicle 710 via first and second pivot arms 752A and 752B; pivot arm 752A pivotally attaches seat 720, in proximity to a front end 721 of seat 720, to chassis 750 via pivotal couplings 754A and 761 on either end of pivot arm 752A, and, in a similar manner, pivot arm 752B pivotally attaches seat 720, in proximity to a rear end 722 of seat 720, to chassis 750 via pivotal couplings 754B and 762 on either end of pivot arm 752B. FIG. 16 further illustrates a shock absorber 756 pivotally attached between pivotal coupling 762 of seat 720 and a pivoting link 758, which is pivotally attached to another portion of chassis 750, thereby providing a cushioned ride during sport mode operation. Although FIG. 16 shows shock absorber 756 as a support for seat 720 in the second position, it should be noted that embodiments of the present invention need not include a shock absorber as a seat support, for example a seat support similar to seat support 156 described in conjunction with FIGS. 6A-B may be incorporated along with pivot arms 752A-B.

FIG. 17A illustrates one embodiment of an adjustable assembly including an interchangeable foot support member 85 reversibly coupled to a support fixture 80, which is mounted on chassis 612, and to a running board 89 of chassis 612. FIG. 17B is a schematic side view of the footrest assembly shown in FIG. 17A illustrating with phantom lines two alternate interchangeable foot support members. As can be seen in FIG. 17A support member 85 holds a foot at an intermediate position 802 between a relatively aft position 801 of one of the alternate members, and a relatively fore position 803 of the other of the alternate members.

According to the embodiment illustrated in FIGS. 17A-B, each of the interchangeable foot support members, illustrated in FIG. 17A by foot support member 85, includes at least one groove 88 for engaging support fixture 80 and two slots 82 for receiving projections 81 of support fixture 80, each of which projection 81 is adapted to receive a clip 83 that locks foot support member 85 to fixture 80. FIGS. 17A-B further illustrates foot support member 85 including a cavity 86 to receive a foot of a rider and an opposing cavity 87 which may be used for storage, for example of a tool kit; foot support member may be molded from a hard plastic, preferably high density polyethylene.

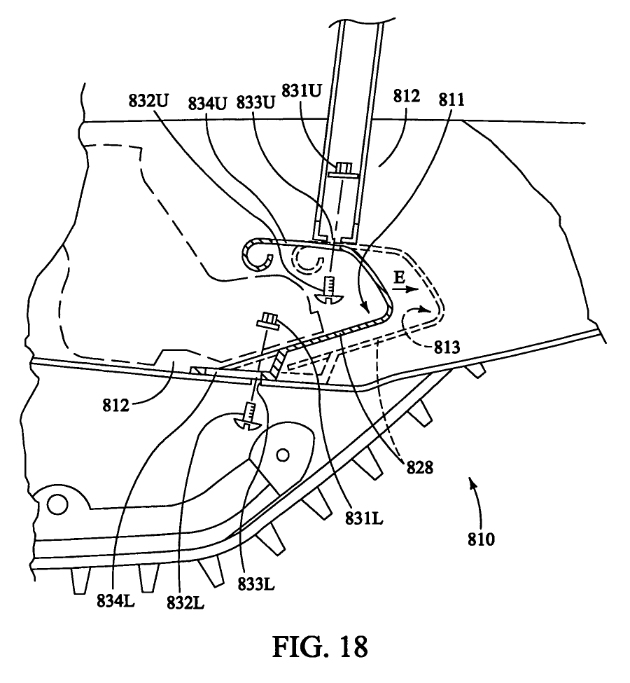

FIG. 18 is a side view of an adjustable footrest assembly according to another embodiment of the present invention. FIG. 18 illustrates a foot support member 828 adjustably positioned along a chassis 812 of a vehicle 810 from a first position 811 to a second position 813, per arrow E, and visa versa; solid lines show member 828 generally aft corresponding to first position 811 and phantom lines show member 828 generally fore corresponding to second position 813. According to the illustrated embodiment, an upper slot 833U of chassis 812 is aligned with a portion of an upper slot 834U of foot support member 828 to accommodate an upper nut 831U and an upper bolt 832U, and a lower slot 833L of chassis 812 is aligned with a portion of a lower slot 834L of member 828 to accommodate a lower bolt 832L and a lower nut 831L; upper and lower nuts and bolts 831U, L and 832U, L, respectively, serve to secure foot support member 828 to chassis 812, upper and lower slots 834U and 834L of foot support member 828 being of such a size as to allow the securing of member 828 in both the generally fore position 813 and in the generally aft position 811.

FIGS. 19A-B are a top view and a section view, respectively, of a footrest 900 according to yet another embodiment of the present invention; such a footrest would be incorporated into a vehicle as depicted for footrest 520 in FIGS. 11 and 12. FIG. 19A illustrates footrest 900 including a first foot support surface 98 and second foot support surface 908 having a side portion, generally denoted by 938, extending laterally outward from first surface 98, and a forward potion, generally denoted by 948, extending forward from first surface 98; second foot support surface 908 along with side portion 938 and forward portion 948, are designated as a fore portion 950 of footrest 900. FIG. 19A further illustrates a side bar 90 bounding outer edges of first and second surfaces 98, 908, which may prevent a rider's foot from sliding laterally off footrest 900; according to alternate embodiments, for example surface 521 of footrest 520 illustrated in FIG. 12, a side bar, such as side bar 90, extends only along the outer edge second footrest surface 908. According to some embodiments of the present invention, first surface 98 of footrest 900 is generally horizontal and accommodates a first foot position of a rider, generally denoted at 961 with phantom lines, and second surface 908 is inclined upward from first surface 98 (FIG. 19B) about an axis 918 to accommodate a second foot position of a rider, generally denoted at 962 with solid lines. FIG. 19A further illustrates axis 918 approximately perpendicular to a line 928, and outward and forward extensions 938 and 948 of second surface 908 accommodating an outward angling of second foot position 962 along line 928, which is skewed from a longitudinal vehicle axis 920 at an angle 925 which may be between approximately ten degrees and approximately thirty-five degrees, preferably between twenty and twenty-five degrees.

First foot position 961 may correspond to a more aggressive riding mode, for example the sport mode previously described, wherein a seat of the vehicle is in a more forward and/or higher position, whereas second foot position 962 may correspond to a more relaxed riding mode, for example the touring mode previously described, wherein the seat is in a more rearward and/or lower position. In each of these positions, the corresponding foot support surface may be approximately perpendicular to a line of force applied through a rider's leg to the rider's foot.

FIG. 19B is a section of fore portion 950 of footrest 900, through section line F-F of FIG. 19A, according to one embodiment. FIG. 19B illustrates the upward inclination of second surface 908 and further shows second surface 908 pivotally adjustable according to some embodiments of the present invention, wherein second surface 908 is joined, in proximity to first surface 98, to a chassis of a vehicle by a pivotal coupling 980 that allows second surface 908 to pivot about axis 918 (FIG. 19A). According to the illustrated embodiment, a locking pin 968, positioned through one of a number of holes 910 in a rail 915, which is coupled to fore portion 950 of footrest 900, for example by a nut and bolt as illustrated, couples portion 950 to a strut 917 of the chassis of the vehicle to hold up surface 908 at an angle 985 which may be adjusted between approximately zero degrees and approximately forty degrees; phantom lines in FIG. 19B show preferable angles of surface 908 at approximately ten degrees and approximately twenty degrees with angle 985 at approximately thirty degrees.

FIG. 19B further illustrates pivotal coupling 980 of second footrest surface 908 including a cavity 981, formed in fore portion 950 of footrest 900 beneath second surface 908, in which an insert 983, which is mounted on an end of a support bar 984, is disposed. According to one embodiment, insert 983 is elastically deformable to allow pivoting of surface 908; according to an alternate embodiment, an interface between cavity 981 and insert 983 is lubricious allowing movement of an inner surface of cavity 981 about insert 983 when second surface 908 is pivoted. According to some embodiments of the present invention, insert 983 being elastically deformable may dampen some vibration during vehicle travel; further dampening may also be implemented in a footrest, for example, as illustrated in FIG. 19B, by disposing an isolator element 953 between fore portion 950 of footrest 900 and rail 915.

According to some embodiments of the present invention, the adjustments of various vehicle elements, for example seat, handle bars and footrests, with respect to one another, for example as described in conjunction with FIGS. 3A-B, 4A-B and 15A-B, are electronically programmed parameters stored in a memory storage device incorporated within the vehicle. Thus a particular rider may retrieve a selection of adjustments, for example via a keypad located on a dash of the vehicle, and thereby send a signal to a controller that electronically makes the adjustments, either before embarking on the vehicle or on the fly, for example to change from a touring mode to a sport mode or visa versa.

Finally, one skilled in the art will appreciate that the present invention can be practiced with embodiments other than those disclosed. The disclosed embodiments are presented for purposes of illustration, not limitation, and numerous other embodiments and uses are intended to be encompassed by the claims attached hereto.

1. A vehicle defining a center of gravity, comprising:
a chassis;
an adjustable seat supported by the chassis and adapted to accommodate a rider in a straddle fashion;
a steering member supported by the chassis for steering the vehicle;
a seat adjustment assembly permitting the seat to be adjusted to first and second seat positions, the first seat position placing the rider straddling the seat in a relatively rearward position with respect to the chassis, the second seat position placing a rider straddling the seat in a relatively forward position, with respect to the chassis, and closer to a vertical alignment with the center of gravity than the first seat position; and
an adjustable steering assembly permitting the steering member to be adjusted to relatively fore and aft positions relative to the chassis, the fore position locating the steering member in an ergonomic location for the rider with the seat adjusted to the second or forward seat position, and the aft position locating the steering member in an ergonomic location for the rider with the seat adjusted to the first or rearward seat position.

2. The vehicle of claim 1, wherein the seat adjustment assembly permits rotation of the seat about a pivot axis between the first and second positions, thereby changing an angular orientation of the seat with respect to the chassis of the vehicle.

3. The vehicle of claim 1, wherein the seat adjustment assembly permits fore and aft movement of the seat between the first and second positions while generally maintaining a generally constant angular orientation of the seat with respect to the chassis of the vehicle.

4. The vehicle of claim 1, wherein the seat adjustment assembly includes a pivotal attachment coupling the seat to the chassis of the vehicle.

5. The vehicle of claim 4, wherein:
the seat includes a front end and a back end, the pivotal attachment being located in proximity to the front end; and
the seat adjustment assembly includes a seat support coupled to the chassis and adapted to support the back end of the seat in at least the second seat position.

6. The vehicle of claim 5, wherein the seat support includes a shock absorber.

7. The vehicle of claim 5, wherein the seat support includes a shock absorber and an arm, the arm having a first end and a second end, the arm being pivotally coupled to the chassis at the first end and pivotally coupled to the shock absorber at the second end, and the shock absorber extending from the arm to a pivotal coupling with the seat.

8. The vehicle of claim 1, wherein the seat adjustment assembly comprises a seat pivot arm extending from the seat to terminate in a first end, the first end of the pivot arm being pivotally attached to the chassis of the vehicle.

9. The vehicle of claim 8, wherein the first end of the pivot arm comprises a pivot rod for pivotally attaching the pivot arm to the chassis.

10. The vehicle of claim 8, wherein
the seat includes a front end and a back end, the first end of the pivot arm being located in proximity to the front end, and
the seat adjustment assembly further comprises a seat support coupled to the chassis and adapted to support the back end of the seat.

11. The vehicle of claim 8, wherein the first end of the pivot arm is enclosed within a housing extending from the chassis of the vehicle.

12. The vehicle of claim 1, wherein the seat adjustment assembly comprises a slideably engaged runner and a track, the runner coupled to one of the seat and the chassis, the track coupled to the other of the one of the seat and the chassis, whereby the runner and track permit sliding movement of the seat fore and aft along the chassis.

13. The vehicle of claim 12, wherein the seat adjustment assembly further comprises a latch adapted to reversibly lock the seat in a position along the chassis.

14. The vehicle of claim 1, further comprising a footrest assembly adapted to provide ergonomic support to a foot of the rider with the seat adjusted to the first position and to the foot of the rider with the seat adjusted to the second position.

15. The vehicle of claim 14, wherein the footrest assembly includes a foot support surface that is pivotally adjustable.

16. The vehicle of claim 14, wherein the footrest assembly comprises a foot support member adapted to move and aft along the chassis of the vehicle.

17. The vehicle of claim 14, wherein the footrest assembly comprises a support fixture mounted on the chassis and a plurality of interchangeable foot support members adapted for reversible coupling to the support fixture, each of the plurality of interchangeable members having a different configuration to support the foot of the rider in a different position with respect to the chassis of the vehicle.

18. The vehicle of claim 17, wherein each of the plurality of interchangeable foot support members includes a first cavity adapted to receive the foot of the rider and a second cavity adapted for storage.

19. The vehicle of claim 14, wherein the footrest assembly includes a foot support member securable to the chassis of the vehicle in a first foot support position and in a second foot support position.

20. A vehicle, comprising:
a chassis;
an adjustable seat supported by the chassis and adapted to accommodate a rider in a straddle fashion;
a steering member supported by the chassis for steering the vehicle;
a seat adjustment assembly permitting the seat to be adjusted to a first seating position and to a second seating position;
an adjustable steering assembly permitting the steering member to be adjusted to a first position and to a second position, the first position locating the steering member in an ergonomic location for the rider with the seat adjusted to the first seating position, and the second position locating the steering member in an ergonomic location for the rider with the seat adjusted to the second seating position; and
a footrest assembly adapted to provide ergonomic support to a foot of the rider with the seat adjusted to the first seating position and with the seat adjusted to the second seating position.

21. The vehicle of claim 20, wherein the first and second seat positions are positions rearward and forward, respectively, relative to the chassis.

22. The vehicle of claim 20, wherein the first and second seating positions are lower and higher, respectively, relative to the chassis.

23. The vehicle of claim 20, wherein the adjustable seat moves in an angular fashion from the first seating position to the second seating position.

24. The vehicle of claim 20, further comprising a seat support coupled to the chassis, and wherein the seat includes a back end, the seat support being adapted to support the back end of the seat at least in the second seat position.

25. The vehicle of claim 24, wherein the seat support includes a shock absorber.

26. The vehicle of claim 20, wherein the seat adjustment assembly includes a pivotal attachment coupling the seat to the chassis of the vehicle.

27. The vehicle of claim 20, wherein the footrest assembly includes a first upper surface accommodating a first foot position of the rider and a second upper surface accommodating a second foot position of the rider.

28. The vehicle of claim 27, wherein the first upper surface of the footrest assembly is inclined vertically at an angle with respect to the second upper surface.

29. The vehicle of claim 28, wherein the first upper surface extends laterally from the second upper surface allowing the foot of the rider to angle outward with respect to a longitudinal centerline of the vehicle.

30. The vehicle of claim 20, wherein the footrest assembly is adjustable.

31. The vehicle of claim 30, wherein the footrest assembly includes a foot support surface that is pivotally adjustable.

32. The vehicle of claim 30, wherein the footrest assembly comprises a foot support member adapted to move fore and aft along the chassis of the vehicle.

33. The vehicle of claim 30, wherein the footrest assembly includes a support fixture supported by the chassis and a plurality of interchangeable foot support members adapted for reversible coupling to the support fixture, each of the plurality of interchangeable members having a different configuration to support the foot of the rider in a different position with respect to the chassis of the vehicle.

34. The vehicle of claim 33, wherein each of the plurality of interchangeable foot support members includes a first cavity adapted to receive the foot of the rider and a second cavity adapted for storage.

35. The vehicle of claim 30, wherein the footrest assembly includes a foot support member securable to the chassis of the vehicle in a first foot support position and in a second foot support position.

36. The vehicle of claim 22, further comprising a backrest having an upper surface positioned above an upper surface of the seat in the first seating position and positioned approximately flush with an upper surface of the seat in the second seating position.

37. The vehicle of claim 20, wherein the vehicle is a snowmobile.

38. A vehicle, comprising:
an adjustable seat coupled to a chassis of the vehicle, adapted to accommodate a rider in a straddle fashion and to provide the rider with a first seating position and a second seating position;
an adjustable steering assembly supported by the chassis, including a steering member and adapted to position the steering member in a first position corresponding to the first seating position and to position the steering member in a second position corresponding to the second seating position;
a footrest;
a first distance between the first seating position and the first position of the steering member and a second distance between the second seating position and the second position of the steering member, the second distance approximately equal to the first distance; and
a third distance between the footrest and the first seating position and a fourth distance between the footrest and the second seating position, the fourth distance approximately equal to the third distance.

39. The vehicle of claim 38, wherein the first and second seating positions are positions rearward and forward, respectively, relative to the chassis.

40. The vehicle of claim 38, wherein the first and second seating positions are lower and higher, respectively, relative to the chassis.

41. The vehicle of claim 38, wherein the adjustable seat moves in an angular fashion from the first seating position to the second seating position.

42. A method for adjusting a straddle-seat vehicle from a first riding position to a second riding position, the method comprising:
moving the seat of the vehicle from an aft position, corresponding to the first riding position, to a fore position, corresponding to the second riding position, the second riding position being closer to a vertical alignment with a center of gravity of the vehicle; and
moving a handling interface of the vehicle from a first ergonomic handling position, corresponding to the aft position, to a second ergonomic handling position, corresponding to the fore position.

43. The method of claim 42, wherein moving the seat comprises lifting the seat about a pivot point.

44. The method of claim 42, wherein moving the seat comprises sliding the seat along a track.

45. The method of claim 42, further comprising adjusting a footrest of the vehicle from a first ergonomic foot support position, corresponding to the aft position, to a second ergonomic foot support position, corresponding to the fore position.

46. The method of claim 45, wherein adjusting the footrest comprises replacing a first foot support member with a second foot support member.
